(19) United States
(12) Patent Application Publication
(10) Pub. No.: US 2026/0280690 A1
(43) Pub. Date: Sep. 17, 2026

(54) Satellite Communication Method and Apparatus

(71) Applicant: Huawei Technologies Co., Ltd., Shenzhen (CN)

(72) Inventors: Ying Chen, Hangzhou (CN); Jun Wang, Hangzhou (CN)

(73) Assignee: Huawei Technologies Co., Ltd., Shenzhen (CN)

(21) Appl. No.: 19/677,213

(22) Filed: May 14, 2026

Related U.S. Application Data
(63) Continuation of application No. PCT/CN2024/132269, filed on Nov. 15, 2024.

(30) Foreign Application Priority Data
Nov. 15, 2023 (CN) 202311527688.4

(51) Int. Cl. H04B 7/185

(52) U.S. Cl. CPC H04B 7/1855; H04B 7/18589

(57) ABSTRACT

A satellite communication method and an apparatus are provided. The method can be applied to the field of satellite communication. The method includes: receiving extension configuration information; receiving first duration indication information; and extending a first validity duration and/or extending a second validity duration based on the extension configuration information and the first duration indication information. According to the method, a validity duration of position information used for uplink synchronization or mobility management can be separately determined, to improve communication efficiency.

### CROSS-REFERENCE TO RELATED APPLICATIONS

This application is a continuation of International Application No. PCT/CN2024/132269, filed on Nov. 15, 2024, which claims priority to Chinese Patent Application No. 202311527688.4, filed on Nov. 15, 2023. The disclosures of the aforementioned applications are hereby incorporated by reference in their entireties.

### FIELD

This disclosure relates to the field of communication technologies, and in particular, to a satellite communication method and an apparatus.

### BACKGROUND

Compared with terrestrial communication, satellite communication has unique advantages. For example, the satellite communication can provide a wider coverage area, and satellite base stations are not vulnerable to natural disasters or external forces. If the satellite communication is introduced into future communication, communication services can be provided for some areas that cannot be covered by terrestrial communication networks, such as oceans and forests; reliability of the communication can be enhanced, for example, it is ensured that airplanes, trains, and users on these transportation means obtain better communication services; and more data transmission resources are provided for the communication, to improve network rates. Therefore, supporting both the terrestrial communication and the satellite communication is an inevitable trend of the future communication, and has great benefits in terms of wide coverage, reliability, multi-connection, high throughput, and the like.

Currently, the satellite communication has been introduced into a 3rd generation partnership project (3GPP) standard as a communication scenario of 5th generation (5G) communication, and is referred to as a non-terrestrial network (NTN). The NTN supports not only various 5G terminals, but also internet of things (IoT) terminals and the like. Main characteristics of the satellite communication are high mobility and large communication delay. Therefore, in comparison with terrestrial communication, a different characteristic is that the terminals further need to achieve synchronization based on position information (for example, global navigation satellite system (GNSS) information, ephemeris information, or the like) on the basis of uplink synchronization, and further need to perform mobility management based on the position information. The position information changes over time, and therefore has a specific validity duration, to ensure that uplink synchronization or mobility management can be performed within the validity duration. However, if the validity duration is set in an overly conservative manner, the position information is still valid but exceeds the validity duration, so that uplink synchronization or mobility management cannot be performed, resulting in reduced communication efficiency.

### SUMMARY

Embodiments of this disclosure provide a satellite communication method and an apparatus, to separately determine a validity duration of position information used for uplink synchronization or mobility management, so as to improve communication efficiency.

According to a first aspect, an embodiment of this disclosure provides a satellite communication method. The method is applied to a first communication apparatus, and the first communication apparatus may be a terminal device, a chip in the terminal device, or a functional module in the terminal device. The method includes: receiving extension configuration information; receiving first duration indication information; and extending a first validity duration and/or extending a second validity duration based on the extension configuration information and the first duration indication information.

In this embodiment, a validity duration of position information for uplink synchronization or mobility management may be separately determined.

According to a second aspect, an embodiment of this disclosure provides a satellite communication method. The method is applied to a second communication apparatus, and the second communication apparatus is a network device, a chip in the network device, or a functional module in the network device. The method includes: sending extension configuration information; and sending first duration indication information.

With reference to the first aspect or the second aspect, in a possible implementation, the extension configuration information includes first extension configuration information and/or second extension configuration information. The first extension configuration information is used for extending the first validity duration, and the second extension configuration information is used for extending the second validity duration. The first validity duration is a validity duration of the position information used for uplink synchronization, and the second validity duration is a validity duration of the position information used for mobility management.

With reference to the first aspect or the second aspect, in a possible implementation, the first duration indication information indicates a first duration.

According to a third aspect, an embodiment of this disclosure provides a first communication apparatus configured to perform the method according to any one of the first aspect or the possible implementations of the first aspect. The first communication apparatus includes a unit that performs the method according to any one of the first aspect or the possible implementations of the first aspect.

For example, the first communication apparatus may be a terminal device or a chip, and the chip may be used in the terminal device.

According to a fourth aspect, an embodiment of this disclosure provides a second communication apparatus configured to perform the method according to any one of the second aspect or the possible implementations of the second aspect. The second communication apparatus includes a unit that performs the method according to any one of the second aspect or the possible implementations of the second aspect.

For example, the second communication apparatus may be a network device or a chip, and the chip may be used in the network device.

According to a fifth aspect, an embodiment of this disclosure provides a first communication apparatus. The first communication apparatus includes a processor configured to perform the method according to any one of the first aspect or the possible implementations of the first aspect. Alternatively, the processor is configured to execute a program stored in a memory. When the program is executed, the method according to any one of the first aspect or the possible implementations of the first aspect is performed.

In a possible implementation, the memory is located outside the first communication apparatus.

In a possible implementation, the memory is located inside the first communication apparatus.

In this embodiment of this disclosure, the processor and the memory may alternatively be integrated into one device. In other words, the processor and the memory may alternatively be integrated together. For example, the first communication apparatus may be a chip.

In a possible implementation, the first communication apparatus further includes a transceiver. The transceiver is configured to receive a signal or send a signal. For example, the transceiver may be configured to receive extension configuration information and receive first duration indication information. For example, the first communication apparatus may be a terminal device.

According to a sixth aspect, an embodiment of this disclosure provides a second communication apparatus. The second communication apparatus includes a processor configured to perform the method according to any one of the second aspect or the possible implementations of the second aspect. Alternatively, the processor is configured to execute a program stored in a memory. When the program is executed, the method according to any one of the second aspect or the possible implementations of the second aspect is performed.

In a possible implementation, the memory is located outside the second communication apparatus.

In a possible implementation, the memory is located inside the second communication apparatus.

In this embodiment of this disclosure, the processor and the memory may alternatively be integrated into one device. In other words, the processor and the memory may alternatively be integrated together. For example, the second communication apparatus may be a chip.

In a possible implementation, the second communication apparatus further includes a transceiver. The transceiver is configured to receive a signal or send a signal. For example, the transceiver may be configured to send extension configuration information and send first duration indication information. For example, the second communication apparatus may be a network device.

According to a seventh aspect, an embodiment of this disclosure provides a first communication apparatus. The first communication apparatus includes a logic circuit and an interface. The logic circuit is coupled to the interface. The interface is configured to input and/or output information. The logic circuit is configured to perform the method according to any one of the first aspect or the possible implementations.

According to an eighth aspect, an embodiment of this disclosure provides a second communication apparatus. The second communication apparatus includes a logic circuit and an interface. The logic circuit is coupled to the interface. The interface is configured to input and/or output information. The logic circuit is configured to perform the method according to any one of the second aspect or the possible implementations.

According to a ninth aspect, an embodiment of this disclosure provides a computer-readable storage medium. The computer-readable storage medium is configured to store a computer program. When the computer program is run on a computer, the method according to any one of the first aspect or the possible implementations of the first aspect is performed.

According to a tenth aspect, an embodiment of this disclosure provides a computer-readable storage medium. The computer-readable storage medium is configured to store a computer program, and when the computer program is run on a computer, the method according to any one of the second aspect or the possible implementations of the second aspect is performed.

According to an eleventh aspect, an embodiment of this disclosure provides a computer program product. The computer program product includes a computer program or computer code, and when the computer program product is run on a computer, the method according to any one of the first aspect or the possible implementations of the first aspect is performed.

According to a twelfth aspect, an embodiment of this disclosure provides a computer program product. The computer program product includes a computer program or computer code, and when the computer program product is run on a computer, the method according to any one of the second aspect or the possible implementations of the second aspect is performed.

According to a thirteenth aspect, an embodiment of this disclosure provides a computer program. When the computer program is run on a computer, the method according to any one of the first aspect or the possible implementations of the first aspect is performed.

According to a fourteenth aspect, an embodiment of this disclosure provides a computer program. When the computer program is run on a computer, the method according to any one of the second aspect or the possible implementations of the second aspect is performed.

According to a fifteenth aspect, an embodiment of this disclosure provides a communication system. The communication system includes a first communication apparatus and a second communication apparatus. The first communication apparatus is configured to perform the method according to any one of the first aspect or the possible implementations of the first aspect. The second communication apparatus is configured to perform the method according to any one of the second aspect or the possible implementations of the second aspect.

### BRIEF DESCRIPTION OF THE DRAWINGS

FIG. 1 is a diagram of an architecture of a communication system according to an embodiment of this disclosure;

FIG. 2a is a diagram of a satellite communication system in a transparent transmission scenario according to an embodiment of this disclosure;

FIG. 2b is a diagram of a satellite communication system in a regeneration scenario according to an embodiment of this disclosure;

FIG. 2c is a diagram of a satellite communication system in a regeneration scenario according to an embodiment of this disclosure;

FIG. 3 is a schematic flowchart of a satellite communication method according to an embodiment of this disclosure;

FIG. 4 is a diagram of a structure of a communication apparatus according to an embodiment of this disclosure;

FIG. 5 is a diagram of a structure of a communication apparatus according to an embodiment of this disclosure; and

FIG. 6 is a diagram of a structure of a communication apparatus according to an embodiment of this disclosure.

### DETAILED DESCRIPTION

For ease of understanding technical solutions of this disclosure, the following further describes this disclosure with reference to the accompanying drawings.

Terms “first”, “second”, and the like in the specification, claims, and accompanying drawings of this disclosure are merely used to distinguish between different objects, and are not used to describe a specific order. In addition, terms such as “include” and “have” and any other variants thereof are intended to cover a non-exclusive inclusion. For example, processes, methods, systems, products, or devices that include a series of steps or units are not limited to listed steps or units, but instead, optionally further include steps or units that are not listed, or optionally further include other steps or units inherent to these processes, methods, products, or devices. “Embodiments” mentioned herein mean that specific features, structures, or characteristics described in combination with embodiments may be included in at least one embodiment of this disclosure. The phrase shown in various locations in the specification may not necessarily refer to a same embodiment, and is not an independent or optional embodiment exclusive from another embodiment. It may be understood explicitly and implicitly by a person skilled in the art that embodiments described herein may be combined with other embodiments.

In this disclosure, “at least one (item)” means one or more, “a plurality of” means two or more, “at least two (items)” means two, three, or more, and “and/or” is used to describe an association relationship between associated objects, and indicates that three relationships may exist. For example, “A and/or B” may indicate the following three cases: Only A exists, only B exists, and both A and B exist, where A and B may be singular or plural. “Or” indicates that two relationships may exist, for example, only A exists and only B exists. When A and B are not mutually exclusive, it may indicate that three relationships exist, for example, only A exists, only B exists, and both A and B exist. The character “/” generally indicates an “or” relationship between the associated objects. “At least one of the following” or a similar expression thereof means any combination of these items. For example, at least one of a, b, or c may represent: a, b, c, “a and b”, “a and c”, “b and c”, or “a, b, and c”.

A method provided in embodiments of this disclosure may be applied to a non-terrestrial network (NTN) communication system. As shown in FIG. 1, the communication system may include a terminal device, a satellite, and a terrestrial station (which may also be referred to as a gateway station or a gateway station). It may be understood that FIG. 1 shows only one satellite and one terrestrial station. In actual use, an architecture with a plurality of satellites and/or a plurality of terrestrial stations may be used as required. Each satellite may provide a service for one or more terminal devices, each satellite may correspond to one or more terrestrial stations, each terrestrial station may correspond to one or more satellites, or the like. This is not limited in embodiments of this disclosure.

The terminal device is an apparatus having a wireless transceiver function. The terminal device may communicate with an access network device (or referred to as an access device) in a radio access network (RAN). The terminal device may also be referred to as a user equipment (UE), an access terminal, a terminal, a subscriber unit, a subscriber station, a mobile station, a remote station, a remote terminal, a mobile device, a user terminal, a user agent, a user apparatus, or the like. In a possible implementation, the terminal device may be deployed on land, including an indoor or outdoor terminal device, and a handheld or vehicle-mounted terminal device; or may be deployed on water (for example, on a ship). In a possible implementation, the terminal device may be a handheld device, a vehicle-mounted device, a wearable device, a sensor, a terminal in an internet of things, a terminal in an internet of vehicles, an uncrewed aerial vehicle, a terminal device in any form in a 5th generation (5G) network or a future network, or the like that has a wireless communication function. This is not limited in embodiments of this disclosure. For example, communication may further be performed between terminal devices by using device-to-device (D2D) or machine-to-machine (M2M). The terminal device shown in embodiments of this disclosure may alternatively be a device in the internet of things (IoT). The IoT network may include, for example, the internet of vehicles. Communication manners in an internet of vehicles system are collectively referred to as vehicle-to-everything (vehicle-to-X, V2X, where X may stand for anything). For example, the V2X may include vehicle-to-vehicle (V2V) communication, vehicle-to-infrastructure (V2I) communication, vehicle-to-pedestrian (V2P) communication, vehicle-to-network (V2N) communication, or the like.

The terrestrial station may be configured to connect a satellite to a base station, or a satellite to a core network. The satellite may provide a radio access service to a terminal device, schedule a radio resource to an accessed terminal device, and provide a reliable radio transmission protocol, a data encryption protocol, and the like. In an example, the satellite may be an artificial earth satellite, a high-altitude aircraft, or the like that is used as a wireless communication base station, for example, an evolved NodeB (eNB) and a next generation NodeB (gNB). In another example, the satellite may alternatively serve as a relay of these base stations, and transparently transmit signals of these base stations to the terminal device.

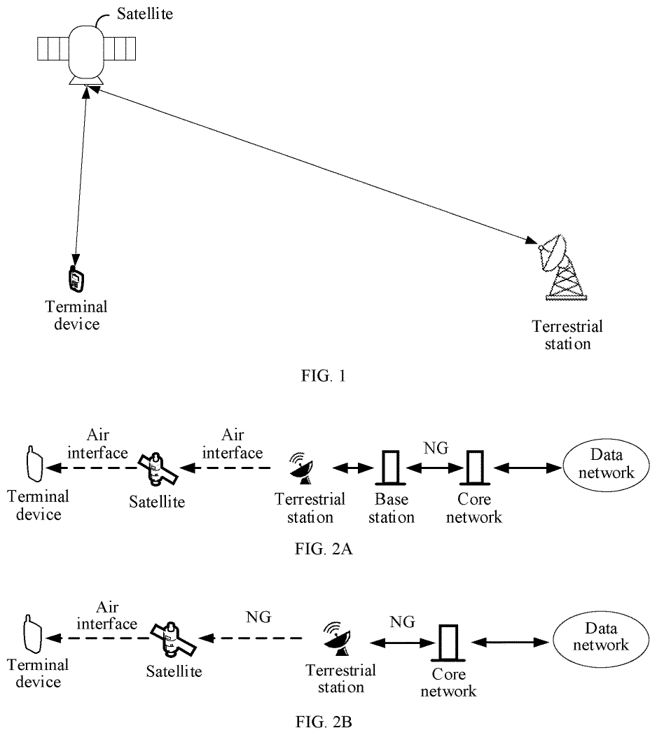

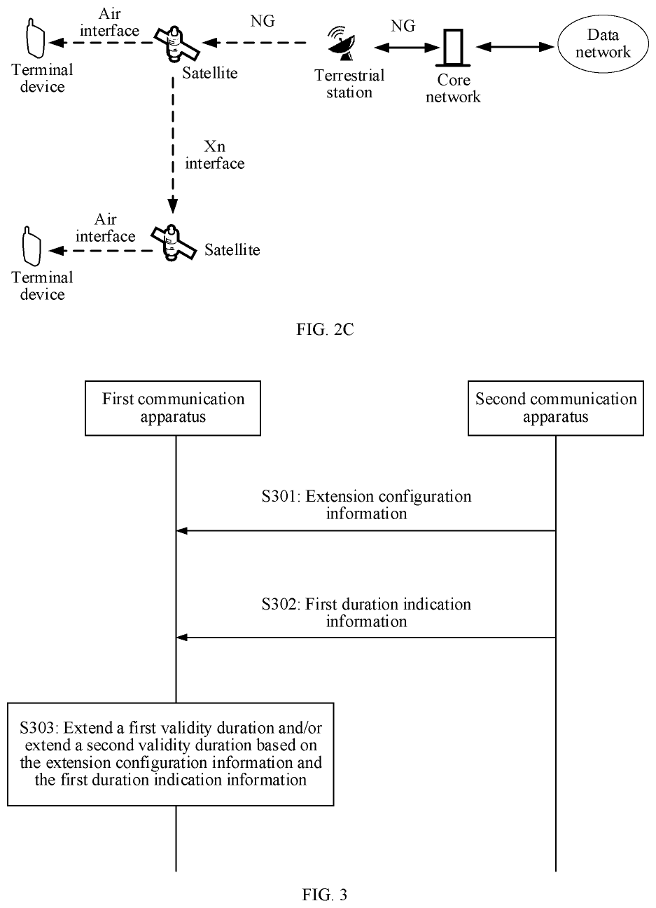

Therefore, in some implementations of this disclosure, for example, in a satellite transparent transmission scenario, a network device may be the base station (which may also be referred to as a ground base station) shown in FIG. 1. FIG. 2a is a diagram of a satellite communication system in a transparent transmission scenario according to an embodiment of this disclosure. For example, a terminal device may access a network through an air interface (where the air interface may be various types of air interfaces, for example, a 5G air interface), and a network device may be deployed on a ground base station. A satellite is connected to a terrestrial station through a radio link. The terrestrial station and the ground base station are connected to a core network in a wired or wireless manner. A radio link may exist between satellites. In the system shown in FIG. 2a, the satellite may have a transparent transmission and forwarding function. In some other implementations of this disclosure, for example, in a regeneration scenario of the satellite, the network device may be the satellite shown in FIG. 1. FIG. 2b is a diagram of a satellite communication system in a regeneration scenario according to an embodiment of this disclosure. For example, a terminal device may access a network through an air interface (where the air interface may be various types of air interfaces, for example, a 5G air interface), and a network device may be deployed on a satellite (for example, in a regeneration mode of the satellite). For example, a base station or some functions of the base station are deployed on the satellite, and signaling exchange and user data transmission between base stations may be completed between satellites, as shown in FIG. 2c.

For example, network elements and interfaces between the network elements in FIG. 2a to FIG. 2c may be shown as follows.

The terminal device may access a satellite network through the air interface and initiate services such as calls and internet access. The base station may be configured to provide a radio access service, schedule a radio resource to an access terminal device, and provide a reliable radio transmission protocol, a data encryption protocol, and the like. The terrestrial station may be configured to be responsible for forwarding signaling and service data between the satellite and the core network. The core network may be configured for user access control, mobility management, session management, user security authentication, charging, or the like. The core network may include a plurality of functional units, for example, functional entities including a control plane and a data plane. For example, the core network shown in FIG. 2a to FIG. 2c may include an access and mobility management function (AMF), a session management function (SMF), a user plane function (UPF), and the like. For example, the AMF may be configured to be responsible for user access management, security authentication, mobility management, and the like. The UPF may be configured to be responsible for managing user plane data transmission, traffic statistics collection, and the like. The air interface shown in FIG. 2a to FIG. 2c may be understood as a radio link between a terminal and the base station, or a radio link between the satellite and the terrestrial station. An Xn interface may be understood as an interface between base stations, and is mainly configured to exchange signaling such as handover. An NG interface may be used as an interface between the base station and the core network, and is configured to exchange signaling such as non-access stratum (NAS) signaling of the core network and service data of a user. In systems using different radio access technologies, names of devices having a base station function may be different, and are not shown one by one in embodiments of this disclosure.

The satellite may be a geostationary earth orbit (GEO) satellite, a medium earth orbit (MEO) satellite or a low earth orbit (LEO) satellite in a non-geostationary earth orbit (NGEO), a high-altitude platform station (HAPS), or the like. A specific type of the satellite is not limited in embodiments of this disclosure.

In some deployments of the network device, the network device may include a central unit (CU) and a distributed unit (DU). In some other deployment of the network device, the CU may further include a CU-control plane (CP) and a CU-user plane (UP). In still some other deployments of the network device, the network device may alternatively be of an open radio access network (ORAN) architecture or the like. A specific deployment manner of the network device is not limited in embodiments of this disclosure. For example, when the network device is of the ORAN architecture, the network device in embodiments of this disclosure may be an access network device in an ORAN, a module in the access network device, or the like. In an ORAN system, the CU may also be referred to as an open (open, O)-CU, the DU may also be referred to as an O-DU, the CU-CP may also be referred to as an O-CU-CP, the CU-UP may also be referred to as an O-CU-UP, and the RU may also be referred to as an O-RU. The deployment manner of the network device listed herein is merely an example. With evolution of a standard technology, the network device may have another deployment manner.

The network architecture and the service scenario described in embodiments of this disclosure are intended to describe the technical solutions in embodiments of this disclosure more clearly, and do not constitute a limitation on the technical solutions provided in embodiments of this disclosure. A person of ordinary skill in the art may know that with the evolution of the network architecture and the emergence of new service scenarios, the technical solutions and the network architecture provided in embodiments of this disclosure are also applicable to similar technical problems.

Currently, there is a communication method based on a short-term connection. In the method, a terminal device initiates random access, and exits a connected mode after sending uplink data. In this process, position information (for example, global navigation satellite system (GNSS) information) obtained by the terminal device before random access remains valid. In other words, the GNSS information remains valid before the terminal device exits an RRC connected mode. Even if the terminal device moves, a GNSS deviation caused by the movement can still meet a synchronization requirement. For an IoT terminal device, because an IoT service is characterized by periodic transmission of a short packet, the foregoing communication method based on a short-term connection may be effectively applicable to a terminal device characterized by periodic transmission of a short packet.

However, the position information obtained by the terminal device in the foregoing method has a specific validity duration. After the position information expires, the terminal device cannot maintain the connection, and needs to exit the connected mode and enter an idle mode. The terminal device performs random access for a plurality of times, and therefore enters the connected mode and exits the connected mode for a plurality of times, resulting in excessive signaling overheads. Alternatively, when the terminal device is in the connected mode for a long time, the position information expires. Therefore, the terminal device needs to re-obtain the position information. However, when the terminal device re-obtains the position information, communication and GNSS measurement may fail to be performed simultaneously. For example, the terminal device may fail to perform communication when performing GNSS measurement.

For example, the validity duration may be a duration determined by the terminal device based on information such as a movement speed of the terminal device, a position of the terminal device relative to a satellite (for example, a position in a central area or an edge area covered by the satellite), or a speed of the terminal device relative to the satellite, and then the terminal device reports the validity duration to a network device. However, when determining the validity duration, the terminal device generally determines the validity duration in a conservative manner, resulting in a short validity duration that is insufficient to support long-term continuous communication of the terminal device. Alternatively, when the terminal device determines the validity duration based on information such as the movement speed, a communication duration required for the terminal device is not taken into account, resulting in a validity duration that is less than the communication duration and that is insufficient to support long-term continuous communication of the terminal device.

In addition, the position information may be further used for mobility management. For mobility management, the position information also has a specific validity duration. However, a validity duration of position information needed for uplink synchronization may be different from a validity duration of position information needed for mobility management.

In view of this, embodiments of this disclosure provide a satellite communication method and an apparatus, to separately configure validity durations of position information for uplink synchronization and mobility management, so as to improve communication efficiency.

In a satellite communication method (as shown in FIG. 3) shown below, a first communication apparatus may be a terminal device, a chip disposed in the terminal device, or a functional module in the terminal device, and a second communication apparatus may be a network device, a chip disposed in the network device, or a functional module in the network device. As described above, the network device may include an access network device, a module, or the like in an O-RAN architecture. For detailed descriptions of the terminal device and the network device, refer to FIG. 1 and FIG. 2a to FIG. 2c. Details are not described herein again. For ease of description, in specific examples, the terminal device and the network device may be used as examples for description below, but this should not be construed as a limitation on embodiments of this disclosure.

FIG. 3 is a schematic flowchart of a satellite communication method according to an embodiment of this disclosure. As shown in FIG. 3, the method includes the following steps.
S301: A second communication apparatus sends extension configuration information. Correspondingly, a first communication apparatus receives the extension configuration information.

The extension configuration information includes first extension configuration information and/or second extension configuration information.

The first extension configuration information is used for extending a first validity duration, and the second extension configuration information is used for extending a second validity duration.

The first validity duration is a validity duration of position information used for uplink synchronization, and the second validity duration is a validity duration of position information used for mobility management.
S302: The second communication apparatus sends first duration indication information. Correspondingly, the first communication apparatus receives the first duration indication information.

The first duration indication information indicates a first duration.
S303: The first communication apparatus extends the first validity duration and/or extends the second validity duration based on the extension configuration information and the first duration indication information.

S302 and S303 may be repeated for a plurality of times. In other words, the first communication apparatus may receive the first duration indication information for a plurality of times, and each time one piece of first duration indication information is received, the validity duration is extended once, so that extension may be performed for a plurality of times. It should be noted that the first communication apparatus receives the first duration indication information and performs extension within the first validity duration or the second validity duration.

Optionally, before S301, the method further includes:
S304: The second communication apparatus determines the extension configuration information.

Optionally, the method further includes:
S305: The first communication apparatus determines the first validity duration and/or the second validity duration.

Optionally, the first communication apparatus sends the first validity duration and/or the second validity duration to the second communication apparatus.

This step is performed before S302, and a sequence of this step and S301 is not limited.

The validity duration in this step means an initial validity duration. In a subsequent step, the initial validity duration is extended, to obtain an updated validity duration.

Extending the validity duration may be understood as adding a segment of extension duration from an end moment of the original validity duration to obtain the updated validity duration. Alternatively, the end moment of the original validity duration is postponed to another moment, to obtain the updated validity duration. Alternatively, an operation, for example, uplink synchronization or mobility management, that is allowed to be performed within the original validity duration may be allowed to be performed within a period of time after the original validity duration expires.

The following describes the method in detail.

The first extension configuration information may include at least one of the following items.
1. First extension indication information

The first extension indication information indicates whether the validity duration is allowed to be extended.

For example, when the first extension indication information is “1”, it indicates that the validity duration is allowed to be extended; or when the first extension indication information is “0”, it indicates that the validity duration is not allowed to be extended.
2. First allowed extension duration

The first allowed extension duration indicates a maximum duration by which the validity duration is allowed to be extended.

The first allowed extension duration may be indicated by a start moment and an end moment, may be indicated by the start moment and a duration, or may be indicated in another manner. This is not limited in this embodiment.

Optionally, the start moment may be defined as the end moment of the original validity duration, and no explicit indication is needed.
3. First allowed quantity of extensions

The first allowed quantity of extensions indicates a maximum allowed quantity of extensions of the validity duration.

Similarly, the second extension configuration information may include at least one of the following: second extension indication information, a second allowed extension duration, and a second allowed quantity of extensions. For an implementation, refer to the first extension configuration information. Details are not described again.

In S302, the first duration is used for determining the extension duration.

Optionally, the extension duration is the first duration.

Optionally, when the first duration is infinite, the extension duration is a first value. The first value may be a value agreed on in a protocol, or a value sent by the second communication apparatus to the first communication apparatus. This is not limited in this embodiment.

Optionally, the first duration indication information in S302 is a timing advance command (TAC). The first duration indicated by the first duration indication information is a validity duration of the TAC. For example, the validity duration of the TAC may be configured by the second communication apparatus via RRC signaling, or may be configured by the second communication apparatus via media access control-control element (MAC-CE) signaling. For example, before S302, the second communication apparatus sends the RRC signaling carrying the validity duration of the TAC or the MAC-CE signaling carrying the validity duration of the TAC. Correspondingly, the first communication apparatus receives the RRC signaling or the MAC-CE signaling. For example, the validity duration of the TAC may be a value ranging from 500 ms to 1024 ms, for example, 500 ms, 750 ms, 1200 ms, 1920 ms, 2560 ms, 5120 ms, or 10240 ms. Examples are not listed one by one herein. Certainly, the validity duration of the TAC listed herein is merely an example and should not be construed as a limitation on this embodiment of this disclosure.

Generally, the second communication apparatus may detect an uplink timing offset error of the first communication apparatus based on an uplink signal sent by the first communication apparatus, and indicate, by using a closed-loop timing offset, the first communication apparatus to perform timing advance adjustment. The first communication apparatus may ensure uplink synchronization through uplink timing advance adjustment. The uplink timing advance adjustment may be calculated based on positions of the first communication apparatus and the second communication apparatus, and the first communication apparatus may further perform fine adjustment based on the closed-loop timing offset indicated by the second communication apparatus.

For example, if the uplink timing offset error detected by the second communication apparatus is less than or equal to a threshold, the second communication apparatus may send the TAC to the first communication apparatus, so that the first communication apparatus can extend the validity duration based on the TAC.

S303 may also be understood as follows: The first communication apparatus determines, based on the extension configuration information and the first duration indication information, whether to extend the validity duration. If the validity duration is to be extended, the extension duration is determined, and extension is performed; or if the validity duration is not to be extended, no extension is performed. Alternatively, S303 may be understood as follows: The first communication apparatus determines the first validity duration and/or the second validity duration based on the extension configuration information and the first duration indication information. The validity duration herein is the updated validity duration.

Based on different content of the extension configuration information, S303 may include the following three implementations.
Implementation 1: The extension configuration information includes the first extension configuration information and the second extension configuration information.

The first communication apparatus may extend the first validity duration based on the first extension configuration information and the first duration indication information, and extend the second validity duration based on the second extension configuration information and the first duration indication information.

The first extension configuration information may be different from the second extension configuration information. In this case, the first validity duration may be different from the second validity duration. In other words, a validity duration of position information used for uplink synchronization may be different from a validity duration of position information used for mobility management. Different validity durations are set for different uses of the position information, to achieve more flexible communication and improve communication efficiency.
Implementation 2: The extension configuration information includes the first extension configuration information.

The first communication apparatus may extend the first validity duration based on the first extension configuration information and the first duration indication information.

Optionally, the first communication apparatus may further extend the second validity duration based on the first extension configuration information and the first duration indication information. The second validity duration and the first validity duration are extended in a same manner. Alternatively, it may be understood that the first validity duration and the second validity duration are the same validity duration, have the same duration, and may be represented by one validity duration. In other words, a uniform validity duration is set without distinguishing the uses of the position information. In this implementation, information transmission overheads can be reduced, and a communication procedure can be simplified.
Implementation 3: The extension configuration information includes the second extension configuration information.

The first communication apparatus may extend the second validity duration based on the second extension configuration information and the first duration indication information.

Optionally, the first communication apparatus may further determine to extend the first validity duration based on the second extension configuration information and the first duration indication information. This implementation is similar to Implementation 2, and details are not described again.

Based on different content of the first extension configuration information, “extending the first validity duration based on the first extension configuration information and the first duration indication information” may include the following three implementations.
Implementation 1: The first extension configuration information includes the first extension indication information.

When the first extension indication information indicates that the validity duration is not allowed to be extended, the first communication apparatus does not extend the first validity duration, or it is understood that the extension duration is 0, and an extended first validity duration is still the original first validity duration. In this case, the first duration indication information is not needed for determining, and S302 is not a necessary step.

When the first extension indication information indicates that the validity duration is allowed to be extended, the first communication apparatus may extend the first validity duration. In this case, the extension duration is determined based on the first duration indication information. For example, the extension duration is the first duration indicated by the first duration indication information.
Implementation 2: The first extension configuration information includes the first allowed extension duration.

The first communication apparatus determines, based on the first allowed extension duration and the first duration, the extension duration for extending the first validity duration.

When a first extension duration determined based on the first duration is less than the first allowed extension duration, the extension duration is the first extension duration. When the first extension duration is greater than the first allowed extension duration, the extension duration is the first allowed extension duration. In other words, the extension duration is determined based on the first duration, and does not exceed the first allowed extension duration.

For a manner of determining the first extension duration, refer to the descriptions of S302 in the foregoing embodiment. For example, the first extension duration may be the first duration or the first value. Details are not described again.

Optionally, the first allowed extension duration is an allowed extension duration relative to the initial validity duration. In other words, when the updated validity duration is extended again, the current extension duration and a previous extension duration need to be accumulated; or it is understood that the previous extension duration needs to be subtracted from the first allowed extension duration; or it is understood that the updated validity duration does not exceed the initial validity duration plus the first allowed extension duration.

In this implementation, a maximum extension duration is limited, to avoid unlimited extension, so as to ensure validity of the position information.
Implementation 3: The first extension configuration information includes the first allowed quantity of extensions.

The first communication apparatus determines, based on the first allowed quantity of extensions and the first duration, the extension duration for extending the first validity duration.

When a quantity of extensions of the initial first validity duration is less than the first allowed quantity of extensions, the first validity duration may be further extended this time, and the extension duration is the first extension duration determined based on the first duration. Determining the first extension duration based on the first duration is similar to the foregoing implementations, and details are not described again.

When the quantity of extensions of the initial first validity duration is greater than or equal to the first allowed quantity of extensions, the first validity duration is not extended, or it is understood that the extension duration is 0, and an extended first validity duration is still the original first validity duration. In this case, the first duration indication information is not needed for determining.

In this implementation, a maximum quantity of extensions is limited, to avoid unlimited extension, so as to ensure validity of the position information.

The foregoing three implementations may be combined with each other. For example, when the first extension configuration information includes the first allowed extension duration and the first allowed quantity of extensions, extension is performed when both the first allowed extension duration and the first allowed quantity of extensions are met. In addition, a part of content included in the first extension configuration information may be implicitly indicated, or a default value is pre-agreed on. For example, when the first extension configuration information includes the first allowed extension duration and/or the first allowed quantity of extensions, the first extension indication information may implicitly indicate that the validity duration is allowed to be extended.

In another embodiment, the first communication apparatus may extend the first validity duration based on a value of the first duration. Different values of the first duration correspond to different manners for determining the extension duration.

For example, when the first duration is infinite, the extension duration is the first value; or when the first duration is finite, no extension is performed, or an allowed quantity of extensions is K, where K is a positive integer, for example, 1.

An implementation in which the first communication apparatus extends the second validity duration based on the second extension configuration information and the first duration indication information is similar to the implementation in which the first communication apparatus extends the first validity duration based on the first extension configuration information and the first duration indication information in the foregoing embodiment. Details are not described again.

It may be understood that the validity duration in the foregoing descriptions includes the first validity duration or the second validity duration, that is, the descriptions of the validity duration are applicable to the first validity duration or the second validity duration.

It may be understood that the position information in the foregoing descriptions may be global navigation satellite system (GNSS) information.

The following describes a communication apparatus provided in embodiments of this disclosure.

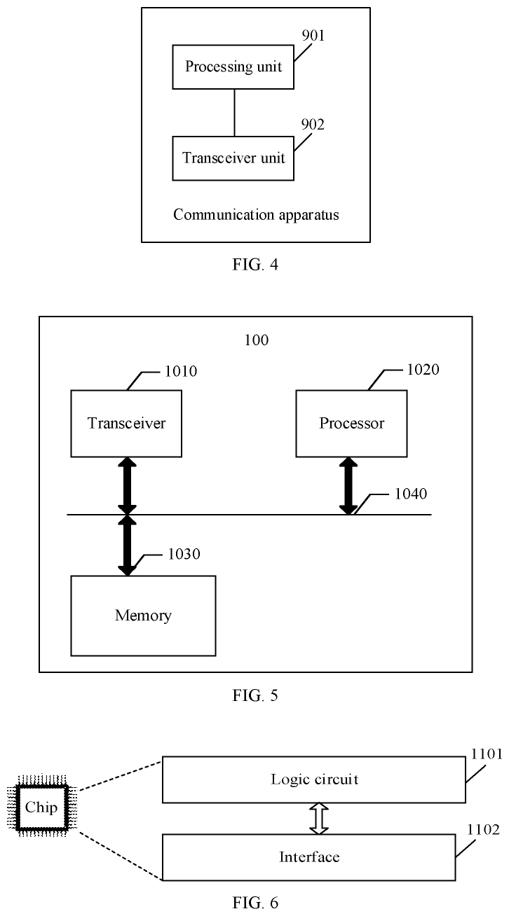

In this disclosure, the communication apparatus is divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, in this disclosure, module division is an example, and is merely a logical function division. In actual implementation, another division manner may be used. The following describes the communication apparatus in embodiments of this disclosure in detail with reference to FIG. 4 to FIG. 6.

FIG. 4 is a diagram of a structure of a communication apparatus according to an embodiment of this disclosure. As shown in FIG. 4, the communication apparatus includes a processing unit 901 and a transceiver unit 902. The transceiver unit 902 may implement a corresponding communication function, and the processing unit 901 is configured to process data. For example, the transceiver unit 902 may also be referred to as an interface, a communication interface, a communication unit, or the like.

In some embodiments of this disclosure, the communication apparatus may be configured to perform an action performed by the first communication apparatus in the foregoing method embodiments. In this case, the communication apparatus may be a terminal device or a component (for example, a chip or a system) that may be configured in the terminal device. The transceiver unit 902 is configured to perform a receiving/sending-related operation of the first communication apparatus in the foregoing method embodiments. The processing unit 901 is configured to perform a processing-related operation of the first communication apparatus in the foregoing method embodiments. The communication apparatus may be configured to perform the steps or functions performed by the first communication apparatus in the foregoing method embodiments.

For example, the transceiver unit 902 is configured to receive extension configuration information and receive first duration indication information.

The processing unit 901 is configured to extend a first validity duration and/or extend a second validity duration based on the extension configuration information and the first duration indication information.

The detailed descriptions of the transceiver unit and the processing unit described in this embodiment of this disclosure are merely examples. For specific functions, performed steps, or the like of the transceiver unit and the processing unit, refer to the foregoing method embodiments. Details are not described herein again.

Optionally, the communication apparatus may further include a storage unit. The storage unit may be configured to store instructions and/or data. The processing unit 901 may read the instructions and/or the data in the storage unit, to cause the communication apparatus to implement the foregoing method embodiments.

FIG. 4 is reused. In some other embodiments of this disclosure, the communication apparatus may be configured to perform an action performed by the second communication apparatus in the foregoing method embodiments. In this case, the communication apparatus may be a network device or a component that may be configured in the network device. The transceiver unit 902 is configured to perform a receiving/sending-related operation of the second communication apparatus in the foregoing method embodiments. The processing unit 901 is configured to perform a processing-related operation of the second communication apparatus in the foregoing method embodiments. The communication apparatus may be configured to perform the steps or functions performed by the second communication apparatus in the foregoing method embodiments.

For example, the processing unit 901 is configured to determine extension configuration information.

The transceiver unit 902 is configured to send the extension configuration information, and send first duration indication information.

It may be understood that the detailed descriptions of the transceiver unit and the processing unit described in this embodiment of this disclosure are merely examples. For specific functions, performed steps, or the like of the transceiver unit and the processing unit, refer to the foregoing method embodiments. Details are not described herein again.

The foregoing describes the communication apparatus in embodiments of this disclosure. The following describes a possible product form of the communication apparatus. It should be understood that any product in any form that has a function of the communication apparatus in FIG. 4 falls within the protection scope of embodiments of this disclosure. It should be further understood that the following descriptions are merely examples, and do not limit the product form of the communication apparatus in embodiments of this disclosure.

In a possible implementation, in the communication apparatus shown in FIG. 4, the processing unit 901 may be one or more processors, and the transceiver unit 902 may be a transceiver. Alternatively, the transceiver unit 902 may be a sending unit and a receiving unit. The sending unit may be a transmitter, and the receiving unit may be a receiver. The sending unit and the receiving unit are integrated into one device, for example, a transceiver. In embodiments of this disclosure, the processor and the transceiver may be coupled, or the like. A manner of a connection between the processor and the transceiver is not limited in embodiments of this disclosure. In a process of performing the foregoing method, a process of sending information in the foregoing method may be understood as a process of outputting the information by the processor. When outputting the information, the processor outputs the information to a transceiver, so that the transceiver transmits the information. After the information is output by the processor, other processing may further need to be performed on the information before the information arrives at the transceiver. Similarly, a process of receiving information in the foregoing method may be understood as a process of receiving the input information by the processor. When the processor receives the input information, the transceiver receives the information, and inputs the information into the processor. Further, after the transceiver receives the information, other processing may need to be performed on the information before processed information is input into the processor.

As shown in FIG. 5, a communication apparatus 100 includes one or more processors 1020 and a transceiver 1010.

For example, when the communication apparatus is configured to perform the steps, the methods, or the functions performed by the first communication apparatus, the transceiver 1010 is configured to receive extension configuration information, and receive first duration indication information.

The processor 1020 is configured to extend a first validity duration and/or extend a second validity duration based on the extension configuration information and the first duration indication information.

It may be understood that for detailed descriptions of the processor and the transceiver, refer to the descriptions of the processing unit and the transceiver unit shown in FIG. 4. Details are not described herein again.

In implementations of the communication apparatus shown in FIG. 5, the transceiver may include a receiver machine and a transmitter machine. The receiver machine is configured to perform a receiving function (or operation), and the transmitter machine is configured to perform a transmitting function (or operation). In addition, the transceiver is configured to communicate with another device/apparatus through a transmission medium.

Optionally, the communication apparatus 100 may further include one or more memories 1030, configured to store program instructions and/or data. The memory 1030 is coupled to the processor 1020. The coupling in this embodiment of this disclosure may be an indirect coupling or a communication connection between apparatuses, units, or modules in an electrical form, a mechanical form, or another form, and is used for information exchange between the apparatuses, the units, or the modules. The processor 1020 may cooperate with the memory 1030. The processor 1020 may execute the program instructions stored in the memory 1030. Optionally, at least one of the one or more memories may be included in the processor.

A specific connection medium between the transceiver 1010, the processor 1020, and the memory 1030 is not limited in embodiments of this disclosure. In this embodiment of this disclosure, in FIG. 5, the memory 1030, the processor 1020, and the transceiver 1010 are connected through a bus 1040. The bus is represented by using a bold line in FIG. 5. A connection manner between other components is merely an example for description, and is not limited thereto. The bus may be classified into an address bus, a data bus, a control bus, and the like. For ease of representation, only one bold line is used for representation in FIG. 5, but this does not mean that there is only one bus or only one type of bus.

In this embodiment of this disclosure, the processor may be a general-purpose processor, a digital signal processor, an application-specific integrated circuit, a field programmable gate array or another programmable logic device, a discrete gate or transistor logic device, a discrete hardware component, or the like. The processor can implement or execute the methods, the steps, and the logical block diagrams disclosed in embodiments of this disclosure. The general-purpose processor may be a microprocessor or any conventional processor or the like. The steps of the methods disclosed in combination with embodiments of this disclosure may be directly implemented by a hardware processor, or may be implemented by using a combination of hardware and software modules in the processor, or the like.

In this embodiment of this disclosure, the memory may include but is not limited to a non-volatile memory such as a hard disk drive (HDD) or a solid-state drive (SSD), a random access memory (RAM), an erasable programmable read-only memory (EPROM), a read-only memory (ROM), or a compact disc read-only memory (CD-ROM). The memory is any storage medium that can be used to carry or store program code in a form of an instruction or a data structure and that can be read and/or written by a computer (for example, the communication apparatus shown in this disclosure). However, this is not limited thereto. The memory in embodiments of this disclosure may alternatively be a circuit or any other apparatus that can implement a storage function, and is configured to store the program instructions and/or the data.

The processor 1020 is mainly configured to process a communication protocol and communication data, control the communication apparatus, execute a software program, and process data of the software program. The memory 1030 is mainly configured to store the software program and the data. The transceiver 1010 may include a control circuit and an antenna. The control circuit is mainly configured to perform conversion between a baseband signal and a radio frequency signal and process the radio frequency signal. The antenna is mainly configured to send and receive a radio frequency signal in a form of an electromagnetic wave. An input/output apparatus, such as a touchscreen, a display, or a keyboard, is mainly configured to receive data input by a user and output data to the user.

After the communication apparatus is powered on, the processor 1020 may read the software program in the memory 1030, interpret and execute instructions of the software program, and process the data of the software program. When data needs to be sent in a wireless manner, the processor 1020 performs baseband processing on to-be-sent data, and then outputs a baseband signal to a radio frequency circuit. The radio frequency circuit performs radio frequency processing on the baseband signal, and then sends a radio frequency signal in a form of electromagnetic wave via the antenna. When data is sent to the communication apparatus, the radio frequency circuit receives a radio frequency signal via the antenna, converts the radio frequency signal into a baseband signal, and outputs the baseband signal to the processor 1020. The processor 1020 converts the baseband signal into data and processes the data.

In another implementation, the radio frequency circuit and the antenna may be disposed independently of the processor that performs baseband processing. For example, in a distributed scenario, the radio frequency circuit and the antenna may be disposed remotely and independently of the communication apparatus.

It may be understood that the communication apparatus shown in this embodiment of this application may further include more components and the like than those in FIG. 5. This is not limited in embodiments of this disclosure. The methods performed by the processor and the transceiver are merely examples. For specific steps performed by the processor and the transceiver, refer to the methods described above.

For example, an embodiment of this disclosure further provides a network device. The network device may include an active antenna unit (AAU) and a baseband unit (BBU). The BBU may be a component of a distributed base station, and mainly completes baseband processing (for example, channel coding, channel demodulation, modulation, and demodulation) of a signal, provides functions such as transmission management and an interface, manages radio resources, and provides a clock signal.

In another possible implementation, in the communication apparatus shown in FIG. 4, the processing unit 901 may be one or more logic circuits, and the transceiver unit 902 may be an input/output interface, or referred to as a communication interface, an interface circuit, an interface, or the like. Alternatively, the transceiver unit 902 may be a sending unit and a receiving unit. The sending unit may be an output interface, the receiving unit may be an input interface, and the sending unit and the receiving unit are integrated into one unit, for example, an input/output interface. As shown in FIG. 6, a communication apparatus shown in FIG. 6 includes a logic circuit 1101 and an interface 1102. In other words, the processing unit 901 may be implemented by using the logic circuit 1101, and the transceiver unit 902 may be implemented by using the interface 1102. The logic circuit 1101 may be a chip, a processing circuit, an integrated circuit, a system on chip (SoC) chip, or the like. The interface 1102 may be a communication interface, an input/output interface, a pin, or the like. For example, FIG. 6 shows an example in which the communication apparatus is a chip. The chip includes the logic circuit 1101 and the interface 1102.

In this embodiment of this disclosure, the logic circuit and the interface may be coupled to each other. A specific manner of connection between the logic circuit and the interface is not limited in embodiments of this disclosure.

For example, when the communication apparatus is configured to perform the methods, the functions, or the steps performed by the first communication apparatus, the interface 1102 is configured to receive extension configuration information and receive first duration indication information; and the logic circuit 1101 is configured to extend a first validity duration and/or extend a second validity duration based on the extension configuration information and the first duration indication information.

It may be understood that the communication apparatus shown in embodiments of this disclosure may implement the methods provided in embodiments of this disclosure in a form of hardware, or may implement the methods provided in embodiments of this disclosure in a form of software, or the like. This is not limited in embodiments of this disclosure.

For specific implementations of the embodiment shown in FIG. 6, further refer to the foregoing embodiments. Details are not described herein again.

An embodiment of this disclosure further provides a communication system. The communication system includes a first communication apparatus and a second communication apparatus. The first communication apparatus and the second communication apparatus may be configured to perform the method in any one of the foregoing embodiments.

In addition, this disclosure further provides a computer program. The computer program is used for implementing an operation and/or processing performed by the first communication apparatus in the methods provided in this disclosure.

This disclosure further provides a computer program. The computer program is used for implementing an operation and/or processing performed by the second communication apparatus in the methods provided in this disclosure.

This disclosure further provides a computer-readable storage medium. The computer-readable storage medium stores computer code. When the computer code is run on a computer, the computer is caused to perform an operation and/or processing performed by the first communication apparatus in the methods provided in this disclosure.

This disclosure further provides a computer-readable storage medium. The computer-readable storage medium stores computer code. When the computer code is run on a computer, the computer is caused to perform an operation and/or processing performed by the second communication apparatus in the methods provided in this disclosure.

This disclosure further provides a computer program product. The computer program product includes computer code or a computer program. When the computer code or the computer program is run on a computer, an operation and/or processing performed by the first communication apparatus in the methods provided in this disclosure are/is performed.

This disclosure further provides a computer program product. The computer program product includes computer code or a computer program. When the computer code or the computer program is run on a computer, an operation and/or processing performed by the second communication apparatus in the methods provided in this disclosure are/is performed.

In the several embodiments provided in this disclosure, it should be understood that the disclosed system, apparatus, and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected based on an actual requirement to implement the technical effects of the solutions provided in embodiments of this disclosure.

In addition, functional units in embodiments of this disclosure may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this disclosure essentially, or the part contributing to the conventional technologies, or all or some of the technical solutions may be implemented in a form of a software product. The computer software product is stored in a readable storage medium and includes a plurality of instructions for instructing a computer device (which may be a personal computer, a server, or a network device) to perform all or some of the steps of the methods described in embodiments of this disclosure. The readable storage medium includes any medium that can store program code, for example, a USB flash drive, a removable hard disk drive, a read-only memory (ROM), a random access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A satellite communication method, wherein the method comprises:
receiving extension configuration information;
receiving first duration indication information; and
extending at least a first validity duration or a second validity duration based on the extension configuration information and the first duration indication information.

2. The method according to claim 1, wherein the first validity duration is a validity duration of position information used for uplink synchronization, and the second validity duration is a validity duration of position information used for mobility management.

3. The method according to claim 1, wherein the extension configuration information comprises at least first extension configuration information or second extension configuration information, the first extension configuration information is used for extending the first validity duration, and the second extension configuration information is used for extending the second validity duration.

4. A communication apparatus, comprising
at least one processor coupled to one or more memories storing programming instructions that, when executed by the at least one processor, cause the communication apparatus to:
receive extension configuration information;
receive first duration indication information; and
extend at least a first validity duration or a second validity duration based on the extension configuration information and the first duration indication information.

5. The communication apparatus according to claim 4, wherein the first validity duration is a validity duration of position information used for uplink synchronization, and the second validity duration is a validity duration of position information used for mobility management.

6. The communication apparatus according to claim 4, wherein the extension configuration information comprises at least first extension configuration information or second extension configuration information, the first extension configuration information is used for extending the first validity duration, and the second extension configuration information is used for extending the second validity duration.

7. A non-transitory computer-readable storage medium storing computer instructions that, when executed by a communication apparatus, cause the communication apparatus to:
receive extension configuration information;
receive first duration indication information; and
extend at least a first validity duration or a second validity duration based on the extension configuration information and the first duration indication information.

8. The non-transitory computer-readable storage medium according to claim 7, wherein the first validity duration is a validity duration of position information used for uplink synchronization, and the second validity duration is a validity duration of position information used for mobility management.

9. The non-transitory computer-readable storage medium according to claim 7, wherein the extension configuration information comprises at least first extension configuration information or second extension configuration information, the first extension configuration information is used for extending the first validity duration, and the second extension configuration information is used for extending the second validity duration.
